(19) United States
(12) Patent Application Publication
(10) Pub. No.: US 2020/0335296 A1
(43) Pub. Date: Oct. 22, 2020

(54) REFLECTION TYPE X-RAY TUBE

(71) Applicant: SUNJE HI-TEK CO., LTD., Busan (KR)

(72) Inventors: Donghoon LEE, Busan (KR); Sanghyo KIM, Busan (KR); Eunmin KIM, Busan (KR); Jeongdong KIM, Ulsan (KR); Donggil JUNG, Busan (KR); Sihwan HEO, Busan (KR); Dongkyu SEOL, Busan (KR)

(73) Assignee: SUNJE HI-TEK CO., LTD., Busan (KR)

(21) Appl. No.: 16/097,833

(22) PCT Filed: Oct. 24, 2018
(86) PCT No.: PCT/KR2018/012598

§ 371 Date: Oct. 30, 2018

(30) Foreign Application Priority Data
May 23, 2018 (KR) 10-2018-0058100

(51) Int. Cl. H01J 35/14; H01J 35/08; H01J 35/18

(52) U.S. Cl. CPC H01J 35/147; H01J 35/18; H01J 35/08

(57) ABSTRACT

This invention relates to an X-ray tube, and more specifically, relates to a reflection type X-ray tube which enables thermoelectrons emitted from filament to reach a target of an X-ray irradiation window more efficiently.

### CROSS REFERENCE TO RELATED APPLICATIONS

This application is the national phase entry of International Application No. PCT/KR2018/012598, filed on Oct. 26, 2018, which is based upon and claims priority to Korean Patent Application No. KR 10-2018-0058100, filed on May 23, 2018, the entire contents of which are incorporated herein by reference.

### TECHNICAL FIELD

This invention relates to an X-ray tube, and more specifically, relates to a reflection type X-ray tube which enables thermoelectrons emitted from filament to reach a target of an X-ray irradiation window more efficiently.

### BACKGROUND

Generally, an X-ray tube uses a cylinder type focusing tube so that the thermoelectrons emitted from the filament can be efficiently moved to the X-ray irradiation window (or the X-ray radiation unit).

Despite the presence of such a focusing tube, the efficiency with which the thermoelectrons emitted from the filament move to the target is low, and it is detached (deviated) from the target due to the thermoelectrons struck by the target. Thereafter, the gaseous impurities collide with the other thermoelectrons and are charged with cations, and the impurities charged by the cation adsorb to the filament part (negative high voltage) located inside the focusing tube to bring down the lifetime of the filament.

The target part furbished for the X-ray tube by conventional technology is consisted of a thin plate member, a target material provided below the thin plate member, and an emission window material provided on the thin plate member.

Such a target part following the conventional technology uses a thin plate member, and the said thin plate member, for instance, withstands only about the thermoelectrons generated by a voltage of approximately 50 kV, and for example, the thermoelectrons of high output generated by applying a high voltage of approximately 80 kV have faced an issue of destruction without being able to withstand it.

### SUMMARY

### Technical Problem

Accordingly, this invention has been made to resolve the said problems. Further, the upper focusing tube and the lower focusing tube are provided, so that the same electric potential is formed in the housing part and the lower focusing tube. Thus, it is the purpose of this invention to provide an invention capable of efficiently moving the thermoelectrons emitted from the filament to the target and reducing the rate of adsorption of impurities to the filament.

However, the purposes of this invention are not limited to the said purposes, and other purposes not mentioned can be clearly understood from the following description for the person skilled in the relevant field of technology.

### Solution to Problem

According to one embodiment of this invention for solving the said issues, this invention includes: a) a thermionic emitter emitting thermoelectrons by application of a negative high voltage; b) a thermoelectrons collecting tube for collecting the thermoelectrons emitted from the thermoelectron emitter; and c) a target part that collides with a thermoelectron passing through the thermoelectron focusing tube part to generate and irradiate X-rays. The top target part may provide a reflection type X-ray tube, which includes the following features of a) a supporting block made of a solid member having a predetermined height; b) an elliptical deposition surface formed to be inclined upwardly from a lower end of the supporting block; and c) a target layer deposited on the deposition surface and generating X-rays by collision with the thermoelectrons.

In addition, preferably, the supporting block is consisted of an oxygen-free copper.

In addition, preferably, the reflection type X-ray tube includes a part of the thermoelectrons emitting part and the thermoelectrons collecting tube part inside. It further includes a tube part formed of an electric leading material, and the thermoelectrically collecting tube part is provided at an upper part of the tube part. An upper focusing tube for receiving the target part therein and a part of the upper part are accommodated in the tube part, and has the feature of the rest of the lower part including the lower focusing tube provided at the lower part of the said tube part.

In addition, preferably, the said upper focusing tube has the feature of including the said X-ray irradiation window provided at the outside of the said irradiation window along with the irradiation part formed in the perpendicular direction from the discharge path of the said thermoelectrons at a height corresponding to the height of the said target to ensure that the X-ray generated from the said target layer is irradiated to the outside together with the reception groove receiving the said target part.

In addition, preferably, the X-ray irradiation window is formed with beryllium.

In addition, preferably, the housing includes a housing part which is spaced apart from the lower surface of the upper focusing tube by a predetermined distance to enclose the tube part and the lower focusing tube. In addition, the X-ray tube is characterized in that the lower focusing tube part and the housing part are formed as the same electric potential so that the moving direction of the thermoelectron is directed to the X-ray irradiation window.

In addition, preferably, the housing part has a length such that an upper end of the housing part is positioned between an upper end part of the tube part and an upper end part of the lower focusing tube, and surrounds the entire lower focusing tube.

In addition, preferably, the said thermionic emission part includes a filament part and a plurality of stem pin parts for applying a negative high voltage to the filament part. The thermoelectron focusing tube part surrounds the filament part, and is arranged to face the lower focusing tube and the lower focusing tube, which firstly concentrate the thermoelectrons emitted from the filament part. Thus, the thermoelectrons emitted from the lower focusing tube include an upper focusing tube that is secondarily focused, and the lower focusing tube and the housing part are formed as the same electric potential. Thus, the moving direction of the thermoelectron is directed from the lower focusing tube to the upper focusing tube.

In addition, preferably, the first, second and third terminals are provided, and a connection part electrically connected to one of the terminals of the board part is included. The said first and second terminals are electrically connected to each of the plurality of stem pin parts, and the third terminal is electrically connected to the connection part. The first and second stem pin parts of the plurality of stem pin parts and the connection part may be at the same electric potential.

In addition, preferably, the said first stem pin part and the connection part are supplied with a negative high voltage for hitting the said target part. The said second stem pin part is supplied with a negative high voltage for discharging hot electrons from the filament part.

In addition, preferably, the said connection part, the lower focusing tube part, and the housing part are electrically connected to each other, so that the same electric potential is formed at a negative high voltage.

In addition, preferably, the said housing part, the said lower focusing tube, and the said connection part are made of a conductive material.

In addition, preferably, the said tube part is made of a ceramic material.

In addition, preferably, the upper focusing tube part and the lower focusing tube part are formed with openings for releasing thermoelectrons or accepting thermoelectrons.

### Technical Effect

As described said, according to this invention, this invention can deposit a target layer on a supporting block having a predetermined height or a predetermined thickness. Therefore, a much thicker target layer can be deposited compared with the conventional straight type X-ray tube, and a much higher output voltage than that of the conventional technology can be applied to generate a high output thermoelectron by the X-rays.

Consequently, this invention has the effect of emitting a high power X-ray to a range of not only the soft X-ray but also the light X-ray range.

In addition, this invention has the effect such that an upper focusing tube is deployed under the X-ray irradiation window, and the housing part and the lower focusing tube are formed as the same electric potential, so that the thermoelectrons emitted from the filament can be efficiently moved to the target.

In addition, according to this invention, a negative high voltage is maintained in the housing part, thereby reducing the rate at which impurities are adsorbed in the filament.

### BRIEF DESCRIPTION OF THE DRAWINGS

The drawings attached to this specification illustrate one preferred embodiment of the invention. In addition, they serve to further understand the technical idea of this invention, together with the detailed description of the invention. Therefore, this invention should not be construed as being limited to the matters described in such drawings.

FIG. 1 is a schematic overall sectional view of a reflection type X-ray tube according to this invention;

FIG. 2 is a schematic exploded cross-sectional view of a reflection type X-ray tube according to this invention;

FIG. 3 is a drawing showing first, second and third terminal parts of the terminal part of this invention;

FIG. 4 is a drawing showing the direction of movement of electrons from the lower focusing tube part toward the upper focusing tube part when the housing part and the lower focusing tube part of this invention are held at the same electric potential; and

FIG. 5 is a drawing showing the direction of movement of electrons from the lower focusing tube part toward the upper focusing tube part when the housing part of this invention is not present.

### DESCRIPTION OF SYMBOLS

10: Direction of electron's movement
1000: Reflection type X-ray tube
1001: Cathode part
1002: Anode part
100: Thermoelectron emitter
110: Multiple stem pins (metal wires)
111: First stem pin part
112: Second stem pin part
120: Filament part
200: Thermoelectron focusing tube
210: First focusing tube (lower focusing tube)
211: Opening
212: First body
213: Second body
214: Upper cylinder part
215: Lower cylinder part
220: Second focusing tube (upper focusing tube)
221: Opening
222: Receiving groove
223: Step part
224: irradiation tube part
225: X-ray irradiation window
230: Flange part
231: Upper annular part
232: Lower annular part
300: Target part
310: Supporting block
320: Deposition surface
330: Target layer
400: Tube part,
500: Housing part (or shielding housing part)
600: Connection part (link wire part or first focusing tube power supply terminal part)
700: Exhaust pipe part
800: Stem part
900: board part (PCB part)
910: First terminal part
920: Second terminal part
930: Third terminal part
940: Same electric potential pad part

### DETAILS DESCRIPTION OF THE EMBODIMENT

Hereinafter, a preferred embodiment of this invention will be described with reference to the drawings. In addition, the embodiment described below does not unduly limit the contents of this invention described in the claims. It should be noted that the entire configuration described in this embodiment is not necessarily essential as the solution means of this invention. In addition, the description of the conventional technology and matters obvious to the person skilled in the relevant field of technology may be omitted. The description of these omitted components (methods) and functions may be fully referred to within the scope of the technical idea of this invention.

Hereinafter, a reflection type X-ray tube 1000 following this invention will be described in detail with reference to the attached drawings.

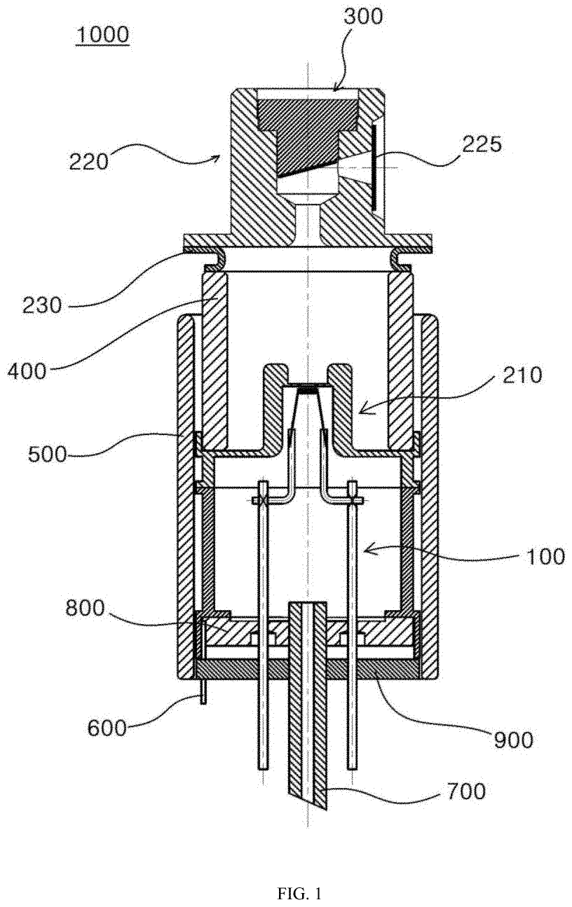

FIG. 1 is a schematic overall sectional view of a reflection type X-ray tube (1000) according to this invention;

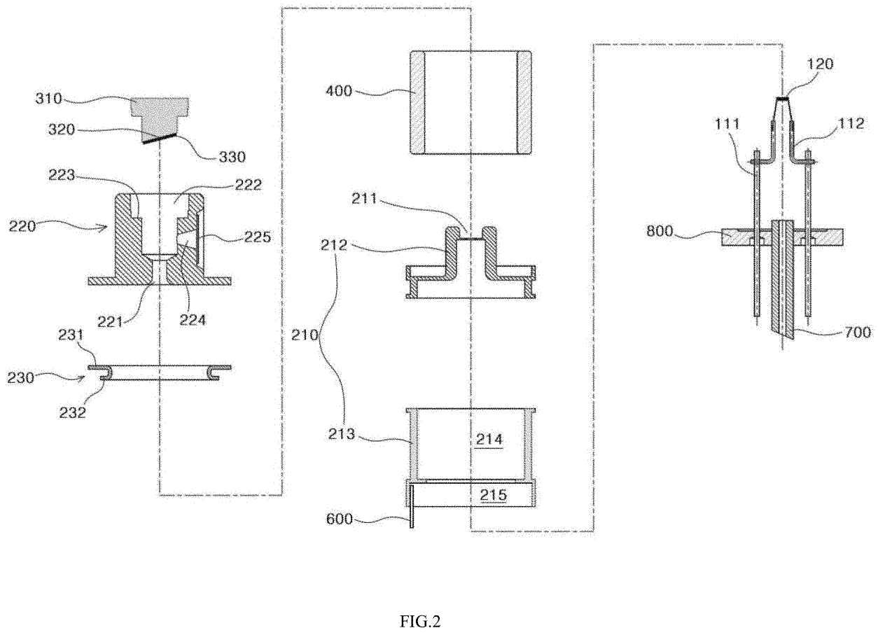

FIG. 2 is a schematic exploded cross-sectional view of a reflection type X-ray tube (1000) according to this invention;

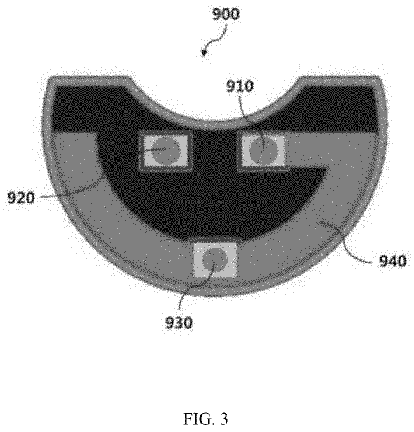

FIG. 3 is a drawing showing the first, second and third terminal parts (910),(920),(930) of the board unit (900) of this invention;

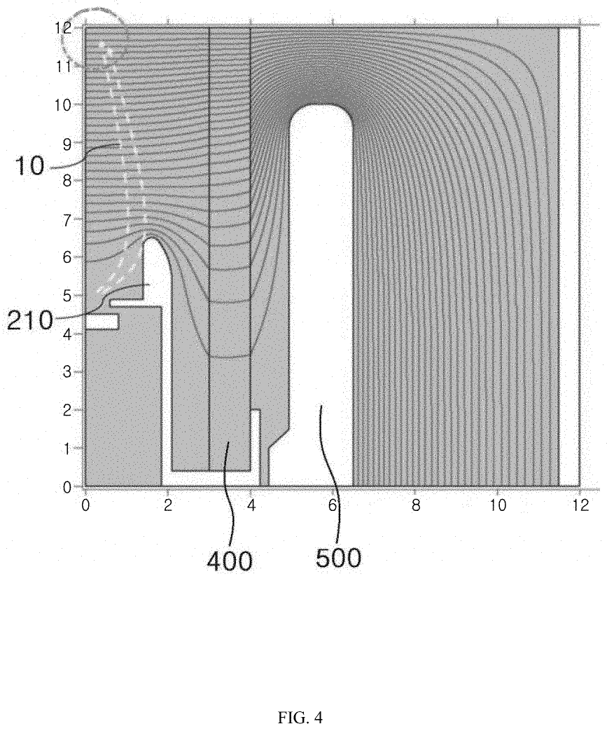

FIG. 4 is a drawing showing a moving direction of electrons from the lower focusing tube (210) toward the upper focusing tube (220) when the housing part (500) and the lower focusing tube (210) of this invention are held at the same electric potential; and

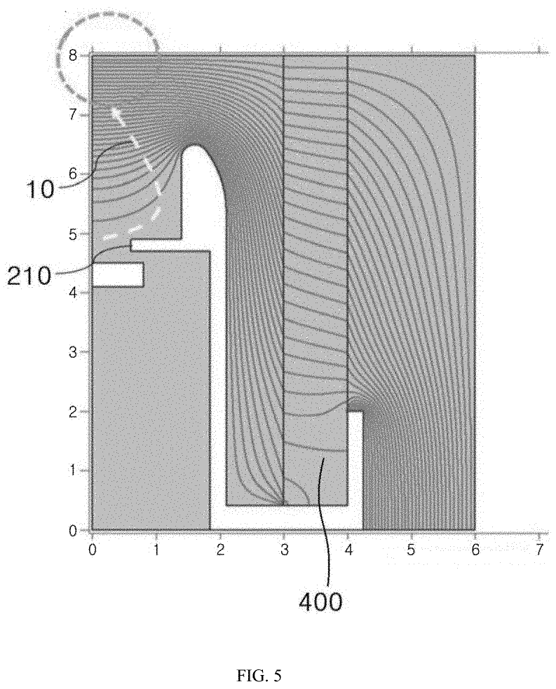

FIG. 5 is a drawing showing a moving direction of electrons from the lower focusing tube (210) toward the upper focusing tube (220) when the housing part (500) of this invention is not present.

As illustrated in FIG. 1 and FIG. 2, a reflection type X-ray tube (1000) according to this invention is roughly consisted of a thermoelectron emitting part (100), a thermoelectric focusing tube part (200), a target part (300), a tube part (400), a housing part (500), a connection part (600, or a link wire part), a getter part (not shown), an exhaust pipe part (700), a stem part (800), and a board part (900).

For reference, the lower focusing tube (210), housing part (500) and the connecting part (600) to be described later form a cathode part (1001), and the upper focusing tube (220), flange part (230), and supporting block (310) to be described later form an anode part (1002).

The said thermionic emission unit (100) includes multiples of stem pins (110, or metal wires) and a filament unit (120).

The said multiples of stem pins (110) are consisted of a first stem pin part (111) and a second stem pin part (112), and preferably, are consisted of an Fe—Ni alloy material or Kovar.

To operate the reflection type X-ray tube (1000), the first stem pin unit (111) is applied with a negative high voltage (or negative high voltage; hereinafter, may be described as a negative high voltage) for striking the target layer output from the high voltage generating unit (not shown) (a value between approximately −1 kV and −80 kV is applied). In addition, a negative high voltage is applied to the second stem pin (112) to discharge the hot electrons from the filament part.

The negative high voltage supplied to the first and second stem pin units (111, 112) is preferably an alternating voltage and is supplied to the first and second stem pins (111, 112) with a different frequency or phase.

Accordingly, the negative AC high voltage supplied from the high voltage generating part is separately supplied to the first and second stem pin parts (111, 112) (the negative high voltage generating part generates a negative DC high voltage and converts it into a negative AC high voltage to supply).

The ground electric potential (or Earth) is formed in the anode (anode part) (1001) or the case (drawing not shown).

The first and second stem pins (111, 112) are electrically connected to the first and second terminal parts (910, 920) of the board unit (900) as shown in FIG. 1. They are electrically connected and accessed to the filament part (120) through the stem part (800) and the getter part (not shown) sequentially with respect to the lower part of the tube part (400).

The first and second stem pin parts (111, 112) are spaced apart from each other by a predetermined distance and penetrate the substantially central area of the stem part (800) and the getter part (not shown).

At this time, since the shape of the stem part (800) and the getter part (not shown) is provided inside the housing part (500) to be described later, it is preferable that the stem part (800) and the getter part have a cylindrical shape.

The filament part (120) is provided inwardly in a substantially central area of the tube part (400) (In FIG. 1, the direction of the X-ray irradiation window is defined as the upward direction, and the direction of the board part is defined as the downward direction), then in the upward direction from the lower end of the tube part (400).

The metal materials used for the filament part may be W (tungsten), an alloy of W and Re (red), an alloy of W and ThO2 (thorium dioxide), etc.

In consideration of the durability of the filament part and the thermionic emission efficiency, it is preferable to use the said materials (including materials not described in this invention) depending on the environment of use.

The thermoelectron focusing tube (200) is provided with a lower focusing tube (210)(that is, a first focusing tube) in a downward area with respect to the longitudinal direction of the tube (400), and an upper focusing tube (220)(that is, a second focusing tube part) is deployed in the upper area.

The thermoelectric focusing tube (200) is made of a conductive metal material (for example, made of SUS material or Kova material), and it is preferable that the approximate shape is a cylindrical shape.

The lower focusing tube (210) is deployed in an area below the tube part (400) to include the filament part (120) inside.

That is, an upper part of the lower focusing tube is accommodated in the tube part, and a part of the upper part is accommodated in the tube part, and the remaining lower part of the lower focusing tube is positioned in the lower part of the tube part.

Accordingly, the lower focusing tube (210) primarily focuses on the thermoelectrons emitted from the filament part (120).

The said upper focusing tube (220) is provided at an upper part of the tube part (400) so as to correspond to the lower focusing tube (210) or to face each other. Thus, it secondarily reflows the thermoelectrons emitted from the lower focusing tube part (210).

A flange part (230) may be provided between the said upper focusing tube (220) and the upper part of the said tube part.

The flange (230) is formed of a Kovar material and includes an upper annular part (231) and a lower annular part (232).

The upper annular part 231 is engaged with the lower surface of the upper focusing tube and the lower annular part (232) is engaged with the upper end of the tube part.

In order to stably support the upper focusing tube, it is preferable that the outer diameter of the upper annular part (231) is larger than the outer diameter of the lower annular part (232).

The upper focusing tube (220) is provided on the upper part of the tube and is configured to receive the target part therein.

More specifically, the upper focusing tube (220) includes a receiving groove, a step part, an irradiation tube part, and an X-ray irradiating window (225).

The said receiving groove has a shape and size corresponding to the outer shape of the target part (300) to accommodate a target part (300) to be described later.

A step part (223) is formed in the said receiving groove (222). The said step (223) is a part where a target part (300) is supported and/or seated.

An irradiation tube part (224) is provided in a lower part of the step part (223) of a side of the said receiving groove (222) so as to communicate with the receiving groove (222).

The irradiating tube part (224) is deployed at a height corresponding to the height of the target layer (330) so that the X-ray generated in the target layer (330) of the target part (300) will be irradiated to the outside in a perpendicular direction towards the said thermoelectron's discharge path (moving path).

The said X-ray irradiating window (225) is provided outside the irradiating tube part (224), and is preferably made of Be (beryllium).

The said X-ray irradiating window (225) serves to irradiate only the light in a wavelength range corresponding to the X-ray area out of various optical wavelengths generated by the collision of the thermoelectrically with the target layer.

The lower focusing tube (210) and the said upper focusing tube (220) are vertically facing each other with respect to the tube part (400) and are spaced apart from each other by a predetermined distance in the longitudinal direction.

The spacing distance may be set in consideration of the length of the tube part (400) and the housing part (500) and the efficiency of the thermoelectron focusing.

Openings (211, 221) are formed in the opposed tip areas of the lower focusing tube (210) and the upper focusing tube (220) to emit or accept hot electrons. It is preferable that the diameter of the opening part (211) of the lower focusing tube is larger than the diameter of the opening part (221) of the upper focusing tube part.

The first body (212) located in the upper area of the lower focusing tube (210) is deployed to surround the filament part (120) and the opening (211) is formed at the apex of the upper part.

The second body (213) located below the said first body is deployed to include a getter unit (not shown) and a stem unit (800) inside.

The lower end of the second body (213) is arranged to be in contact with the upper surface of the board unit (900). The lower end area of the second body (213) is deployed to be electrically connected to the inner wall of the housing part 500 and the connection part 600.

Accordingly, as described later, the housing unit (500), lower focusing tube (210), and the connection unit (600) can be held on the electric potential.

The said first body (212) and the second body (213) may be manufactured as discrete parts, joined together, or integrally formed as illustrated in the FIG. 1.

The said target part (300) is configured to collide with a thermoelectron passing through the thermoelectric focusing tube part (200) to generate and irradiate X-rays.

The said target part (300) is configured to be accommodated in the upper focusing tube (220) at the said upper part of the tube part (400).

Specifically, the said target part (300) includes a supporting block (310), supporting block (310), deposition surface (320), and a target layer (330).

The supporting block (310) is made of a solid member having a predetermined height.

That is, the supporting block (310) is made of a metal material having a substantial thickness, which is a thick film member, unlike the thin film member of the conventional technology's target part.

Preferably, the supporting block (310) may be comprised an oxygen-free copper.

Since the supporting block (310) is made of an oxygen-free copper having excellent thermal conductivity, the said target part can be quickly cooled off in an overheated state after the X-ray generation. In addition, deposition of tungsten, which is mainly used in the target layer, is very easy, and there is an advantage that much less outgassing phenomenon (that is, impurity gas is generated when a thermoelectron strikes the target material in vacuum) relative to SUS.

The said deposition surface (320) is obliquely formed in an upward direction at a lower end of the said supporting block (310) and has an elliptical shape.

The said target layer (330) is deposited on the said deposition surface (320) and is configured to generate X-rays by collision with the thermoelectrons.

Preferably, the said target layer (330) may be comprised of tungsten (W).

An X-ray (preferably a soft X-ray, a hard X-ray) is generated by a target collision of the thermoelectrics, and an X-ray is irradiated to the outside through the X-ray irradiation window (300).

As described said, since a target layer can be deposited on a supporting block having a predetermined height or a predetermined thickness, this invention can deposit a much thicker target layer than a conventional linear X-ray tube. As a result, a much higher output voltage than that of the conventional technology can be applied to generate a high output thermoelectron by X-rays.

In addition, by including the target part (300) as in the said, this invention can also improve the overall service life of the X-ray tube.

The tube part (400) is made of a nonconductive ceramic material, is hollow, and has a cylindrical shape.

Some of the filament part (120) and the lower focusing tube part (210) are provided inside the tube part (400).

The tube part (400) has a cylinder type shape and a predetermined length and diameter in the longitudinal direction.

The diameter of the tube part (400) is set to include a part of the filament part (120) and the lower focusing tube part (210) at a distance from the inside.

Since the tube part (400) is made of a ceramic material, the strength of the tube part (400) is larger than that of a conventional glass material.

The housing part (500) is made of a brass material and is formed to have a cylinder type tube part (400).

More specifically, the said housing part (500) is spaced apart from the lower surface of the upper focusing tube (220) by a predetermined distance so as to surround the tube part (400) and the lower focusing tube (210).

In addition, it is preferable for the housing part (500) to be spaced apart from the bottom of the flange part (230) by a predetermined height so as to substantially surround the tube part (400). It is also preferable that it has a length that allows the board part (900) and the lower focusing tube (210) provided at the lower end of the housing part (500) to be included inwardly in the downward direction.

It is more preferable to have a length that extends slightly upward while including the board part (900) and the lower focusing tube part (210) inward.

Accordingly, the length of the housing part (500) may be set to be two to three times the length of the tube part (400) as shown in FIG. 1.

Preferably, the said housing part has a length such that the upper end of the housing part is located between the upper end of the tube part and the upper end part of the lower focusing tube, and surrounds the entire lower focusing tube.

The housing part (500) is provided such that the tube part (400) is spaced apart from the tube part 400 by a predetermined distance.

The connection part (600, link wire part) is electrically connected to the third terminal part (930) of the board part (900) as shown in FIG. 1 and FIG. 2. The third terminal part (930) is electrically at the same electric potential as the first terminal part (910), and a negative high voltage is applied. Therefore, a negative high voltage is supplied to the connection part (600). In addition, the connection part (600) is electrically connected to the lower inner wall of the lower focusing tube, and the lower outer wall of the lower focusing tube is electrically connected to the lower inner wall of the housing part (500). Accordingly, when a negative high voltage is applied to the connection part (600), the same negative high voltage is applied to the lower focusing tube and the housing part (500) to become the same electric potential. The connection part (600) is arranged in the longitudinal direction through the third terminal part (930) of the base plate part (900) and is deployed below the stem part (800). The connection part (600) may be deployed to support the stem part (800) described later, and may be formed of a conductive material made of Kovar.

As shown in FIG. 2, first, second and third terminal parts (910, 920, 930) are formed on the board part (900) and are provided at the lower ends of the housing part (500). At this time, the terminal means a connection terminal formed on the PCB board. The first and second stem parts (911 and 920 each) pass through the first and second stem pins (111 and 112 each). The connection part (600) is electrically connected to the third terminal part (930).

Since the first terminal part (910) and the third terminal part (930) are electrically connected to each other by the same electric potential pad part (940), a negative AC high voltage is supplied as the same electric potential. In addition, a negative AC high voltage is supplied to the second terminal part (920) while having the same electric potential as that of the first and third terminal parts (910, 930), and the first and third terminal parts and the second terminal part are supplied with negative AC high voltage (frequency or phase is different) is supplied.

The getter is located below the filament part (120) and maintains a vacuum inside the tube part (400).

The stem part (800) is located below the getter part (not shown) and is deployed to match the groove diameter of the lower end area of the second body (212b) of the lower focusing tube. The first and second stem pin parts (111, 112) are electrically connected to both ends of the filament part (120) through the stem part (800) and the getter part (not shown), respectively. Since the stem part (800) is made of a ceramic material, the first and second stem pin parts (111, 112) are electrically insulated from each other. In addition, it can be made smaller than the glass material.

It is preferable that the stem part (800) and the tube part (400) are made of a ceramic material because the voltage is higher than the negative high voltage of the conventional glass material.

The exhaust pipe part (700) is provided as shown in FIG. 1 for the vacuum measurement of a getter part (not shown). That is, the vacuum degree of the getter unit (not shown) is externally measured and connected to external equipment to adjust the vacuum value of the getter unit (not shown) if necessary. The exhaust pipe part (700) is preferably made of Ni (nickel) or a Brass material.

<The Negative High Voltage Supply for the Housing Part and the First Focusing Tube Part>

Meanwhile, when a high negative voltage is applied to the connection part (600), a negative high voltage is similarly formed in the lower focusing tube and the housing part (500) which are electrically connected to the connection part 600. At this time, a negative high voltage is supplied to the lower focusing tube by electrical contact or conduction with the connection part (600), and the housing part (500) is formed by the electrical contact or conduction with the connection part (600), or, a dynamic electric potential can be formed between the lower focusing tube and the lower focusing tube by separately supplying a separate negative high voltage to the housing part (500) (thus, the additional supply terminal can be electrically coupled to the housing part). Accordingly, the lower focusing tube and the housing part (500) are maintained at the same electric potential (a negative high voltage). The technical features of this invention have the following two advantages.

Generally, the target is detached (deviated) from the target due to a thermoelectron striking the target, and consequently, gaseous impurities collide with other thermoelectrons and are charged with positive ions. In addition, impurities charged with such cation are adsorbed to the filament part (a negative high voltage) located inside the lower focusing tube, and the life span of the filament is reduced. Accordingly, in this invention, since a negative high voltage is maintained in the housing part (500), some of the impurities of the positive ions are adsorbed to the inner wall of the tube part (400) in contact with the housing. Therefore, the amount of impurities adsorbed to the filament part (120) can be reduced, and the lifetime of the filament part (120) can be improved.

When a negative high voltage is applied to the connection part (600), a negative high voltage is applied to the housing part (500) and the lower focusing tube in the same manner. Accordingly, the housing part (500) and the lower focusing tube form a mutual electric potential. Thus, the housing part (500) and the lower focusing tube are allowed to have the same electric potential. Thus, as shown in FIG. 4 and FIG. 5, it is possible to remarkably increase the rate at which the thermoelectrons first focused and emitted from the lower focusing tube enter the upper focusing tube. That is, the housing part (500) and the lower focusing tube are formed to have the same electric potential, so that the electron's moving direction of the thermoelectrons emitted from the lower focusing tube is directed towards the upper focusing tube.

FIG. 4 and FIG. 5 illustrate the moving direction (10) of the thermoelectrons directed towards the upper focusing tube by the thermoelectrons emitted from the lower focusing tube (that is, the dotted circle area in FIG. 4 and FIG. 5 corresponds to the area in which the second focusing tube part is located). At this time, it can be seen that the thermoelectrons of FIG. 4 are directed more toward the upper focusing tube than that of FIG. 5. That is, FIG. 5 illustrates that the electrons emitted from the first focusing tube are not directed to the second focusing tube but are moved to the other. The units of the coordinate axes (x-axis and y-axis) illustrated in FIG. 4 and FIG. 5 are, for example, [mm] as a unit of length.

In describing this invention, the description of the conventional technology and the person skilled in the relevant field of technology may be omitted. The description of these omitted components (methods) and functions may be adequately referred to within the scope of the technical idea of this invention.

The configuration and functions of the said-described components have been described separately from each other for the convenience of description, and any of the components and functions may be integrated into other components or may be further subdivided as needed.

While this invention has been described with reference to its embodiment, this invention is not limited hereto, and various modifications and applications are available. That is, any person skilled in the relevant field of technology can easily understand that many variations are available without departing from the substance of this invention. In addition, it must be noted that in the case where it is determined that a specific description of public announcement functions and their configurations relating to this invention or combinations of the configurations of this invention may unnecessarily obscure the substance of this invention, that specific description has been omitted.

What is claimed is:

1. A reflection type X-ray tube, comprising:
a thermionic emitter emitting thermoelectrons by application of a negative high voltage;
a thermionic convergence tube part for concentrating thermoelectrons emitted from the thermionic emitter; and
a target part; wherein the target part collides with a thermoelectron passing through a thermoelectron focusing tube part to generate and irradiate an X-ray, wherein the target part comprise a supporting block made of a solid member having a predetermined height, an elliptic deposition surface formed at an upper end of the supporting block and inclined upward, and a target layer deposited on the elliptic deposition surface and generating X-rays by collision with the thermoelectrons.

2. The reflection type X-ray tube of claim 1, further comprising a tube part including the thermoelectron emitter and a thermoelectrons collecting tube part on an inner side among the thermoelectron focusing tube part,
wherein the supporting block is comprised of an oxygen free copper,
wherein the thermoelectron focusing tube part comprises an upper focusing tube provided on the tube part and accommodating the target part therein, and a lower focusing tube; a part of the lower focusing tube is accommodated in the tube part and which of other part of the lower focusing tube is provided in a lower part of the tube part.

3. The reflection type X-ray tube of claim 2, wherein the upper focusing tube comprises:
a receiving groove receiving the target part;
an irradiation tube part formed at a height corresponding to a height of the target layer so that the X-rays generated in the target layer are irradiated to the outside, in a direction perpendicular to a discharge path of the thermoelectrons; and
an X-ray irradiating window provided on the outer side of the irradiation tube part as a reflection type X-ray tube.

4. The reflection type X-ray tube of claim 2, wherein the reflection type X-ray tube comprises a housing part spaced apart from a lower surface of the upper focusing tube by a predetermined distance so as to surround the tube part and the lower focusing tube,
wherein the reflection type x-ray tube forms the lower focusing tube part and housing part with the same electric potential so that a moving direction of the thermoelectrons is directed towards the X-ray irradiation window,
wherein the housing part has a length such that an upper end of the housing part is located between an upper end of the tube part and an upper end of the lower focusing tube and surrounds the entire lower focusing tube.

5. The reflection type X-ray tube of claim 4, wherein the thermoelectron emitter comprises a filament part; and multiple stem pins applying a negative high voltage to the filament part,
wherein the thermoelectron focusing tube part comprise the lower focusing tube which surrounds the filament part and primarily concentrates thermoelectrons emitted from the filament part, and the upper focusing tube deployed so as to face the said lower focusing tube so as to focus the thermoelectrons emitted from the lower focusing tube, wherein the lower focusing tube and the housing part with the same electric potential so that the moving direction of the thermoelectrons is directed from the lower focusing tube towards the upper focusing tube as the reflection type X-ray tube.

6. The reflection type X-ray tube of claim 5, further comprising:
a board part providing a first, a second, and a third terminals and deployed at an end of the housing part; and a connection part electrically connected to one of the first, the second and the third terminals of the board part,
wherein the first and the second terminals are electrically connected to each of the multiple stem pin parts, and the third terminal is electrically connected to the connection part,
wherein a first and a second stem pin parts among the multiple stem pin parts are of the same electric potential.

7. The reflection type X-ray tube of claim 6, wherein the first stem pin part and the connection part are supplied to a negative high voltage for striking the target part, wherein the second stem pin part is supplied to a negative high voltage for discharging thermoelectrons from the filament part.
